(19) United States
(12) Patent Application Publication
(10) Pub. No.: US 2019/0202005 A1
(43) Pub. Date: Jul. 4, 2019

(54) METHOD FOR MANUFACTURING OPTICAL FILM

(71) Applicant: ZEON CORPORATION, Chiyoda-ku, Tokyo (JP)

(72) Inventor: Takuya MIURA, Tokyo (JP)

(73) Assignee: ZEON CORPORATION, Chiyoda-ku, Tokyo (JP)

(21) Appl. No.: 16/092,874

(22) PCT Filed: Apr. 24, 2017
(86) PCT No.: PCT/JP2017/016140

§ 371 Date: Oct. 11, 2018

(30) Foreign Application Priority Data
Apr. 28, 2016 (JP) 2016-090006

(51) Int. Cl. B23K 26/38; B23K 26/18; B23K 26/0622; G02B 5/30; B29C 48/08; B29C 48/21

(52) U.S. Cl. CPC B23K 26/38; B23K 26/18; B29C 48/21; G02B 5/30; B29C 48/08; B23K 26/0622

(57) ABSTRACT

A method for producing an optical film, including a cutting step of irradiating a layered body with laser light to cut the resin layer, the layered body including a resin layer and a laser absorption layer disposed on one surface of the resin layer, wherein an average absorbance A_{A} of light in a wavelength range of 9 μm or more and 11 μm or less by the laser absorption layer is larger than an average absorbance A_{R} of light in the wavelength range of 9 μm or more and 11 μm or less by the resin layer, and a ratio T_{A}/T_{R} of a thickness T_{A} of the laser absorption layer relative to a thickness T_{R} of the resin layer is 0.8 or more.

### FIELD

The present invention relates to a method for producing an optical film.

### BACKGROUND

An optical film which is formed of a resin is sometimes disposed to a display device such as a liquid crystal display device and an organic electroluminescent display device. Such an optical film is usually formed as a film having a size which is larger than that of a film piece as a final product. Such a film is cut into a desired shape which fits the shape of the display device to be used as an optical film in the display device.

Examples of the method for cutting out a film into a desired shape may include a mechanical cutting method with a knife and a laser cutting method with laser light. Among these, the laser cutting method is preferable, because of low tendency to generate cutting residues.

The cutting of a resin film by a laser is often performed while the resin film is fixed on a support. For example, a layered body including a glass support, and a resin layer and the like disposed on the glass support is prepared, and the resin layer of such a layered body is cut with laser light to obtain an optical film having a desired shape (for example, Patent Literature 1). As the laser light used for such cutting, a variety of examples are known (for example, Patent Literatures 2 and 3). The support may be peeled from the optical film to be reused in the next production, or may be incorporated into a display device as part of the constituent element of the display device together with the optical film.

### CITATION LIST

### Patent Literature

Patent Literature 1: Japanese Patent Application Laid-Open No. 2011-53673 A

Patent Literature 2: Japanese Patent Application Laid-Open No. 2004-42140 A

Patent Literature 3: Japanese Translation of PCT

Patent Application Publication No. 2012-521890 A (Corresponding foreign publication: U.S. Pat. No. 8,350,187)

### SUMMARY

### Technical Problem

For cutting the resin layer by the laser cutting method in a state of being supported by the support, the resin layer is required to be cut without damaging the support. Since an excessive power of laser light has the risk of damaging the support, the power of laser light is required to be small.

Some resin layers have low sensitivity to a laser. For example, a resin containing a cyclic olefin polymer is excellent in transparency, size stability, phase difference expression properties, low hygroscopicity, and stretching properties at low temperature, and thus suitable as an optical member. On the other hand, the resin containing a cyclic olefin polymer is low in the sensitivity to laser light which is often used for cutting the resin layer. Upon cutting such a resin layer with laser light, cutting could become insufficient with laser light having low power, while the damage of the support was likely to be caused with laser light having power increased for achieving sufficient cutting.

Therefore, an object of the present invention is to provide a method for producing an optical film which enables smooth cutting without damaging the support even when the resin layer is low in the sensitivity to a laser.

### Solution to Problem

The present inventor has conducted researches for solving the aforementioned problem. As a result, the inventor has found that a resin layer can be favorably cut without damaging a support by combining the resin layer with a specific laser absorption layer in a laser cutting method. Thus, the present invention has been accomplished.

That is, according to the present invention, the following [1] to [8] are provided.

(1) A method for producing an optical film, comprising a cutting step of irradiating a layered body with laser light to cut the resin layer, the layered body including a resin layer and a laser absorption layer disposed on one surface of the resin layer, wherein

an average absorbance A_{A} of light in a wavelength range of 9 μm or more and 11 μm or less by the laser absorption layer is larger than an average absorbance A_{R} of light in the wavelength range of 9 μm or more and 11 μm or less by the resin layer, and

a ratio T_{A}/T_{R} of a thickness T_{A} of the laser absorption layer relative to a thickness T_{R} of the resin layer is 0.8 or more.

(2) The method for producing an optical film according to (1), wherein the average absorbance A_{A} by the laser absorption layer is 0.07 or more.

(3) The method for producing an optical film according to (1) or (2), wherein the irradiation with the laser light is performed so that an energy distribution of a beam of the laser light is a flat-shape energy distribution.

(4) The method for producing an optical film according to any one of (1) to (3), wherein the resin layer is a layer of a thermoplastic resin containing a cyclic olefin polymer.

(5) The method for producing an optical film according to any one of (1) to (4), wherein the laser absorption layer is a layer of a resin containing an ester compound.

(6) The method for producing an optical film according to (5), wherein the resin containing the ester compound is an acrylic adhesive.

(7) The method for producing an optical film according to any one of (1) to (6), wherein the laser light has a wavelength falling within a range of 9 μm or more and 11 μm or less.

(8) The method for producing an optical film according to any one of (1) to (7), wherein

the cutting step includes forming a support-layered body composite including a support, the laser absorption layer, and the resin layer in this order, and

the irradiation with the laser light includes irradiating the support-layered body composite with the laser light onto a side of the resin layer.

### Advantageous Effects of Invention

According to the method for producing an optical film of the present invention, the cutting of the resin layer can be smoothly performed without damaging the support, even when the resin layer is low in the sensitivity to a laser, thereby enabling the efficient production of a high-quality optical film.

### BRIEF DESCRIPTION OF DRAWINGS

FIG. 1 is a side view illustrating an example of a positional relationship between a support-layered body composite and laser light in a cutting step in a method for producing an optical film according to the present invention.

FIG. 2 is a graph showing an example of an energy distribution of a beam of certain laser light having a flat-shape energy distribution.

FIG. 3 is a graph showing an example of an energy distribution of a beam of Gaussian-mode laser light that is commonly used in prior art.

### DESCRIPTION OF EMBODIMENTS

Hereinafter, the present invention will be described in detail with reference to embodiments and examples. However, the present invention is not limited to the following embodiments and examples, and may be freely modified for implementation without departing from the scope of claims of the present invention and the scope of their equivalents.

In the present application, a direction of a beam and an element used in process steps being “perpendicular” or “parallel” may allow an error within the range of not impairing the advantageous effects of the present invention, unless otherwise specified. Such an error may be usually within a range of ±5°, preferably within a range of ±2°, and more preferably within a range of ±1°.

In the present application, the terms such as “(meth)acryl” and “(meth)acrylate” mean acryl, methacryl or a combination of these. For example, (meth)acrylate means any of an acrylate, a methacrylate, and a combination of these. For example, (meth)acrylamide means any of an acrylamide, a methacrylamide, and a combination of these.

[1. Method for Producing Optical Film: Summary]

The method for producing an optical film according to the present invention includes a cutting step of irradiating a specific layered body with laser light to cut a resin layer of the layered body.

[2. Layered Body, and Support-Layered Body Composite]

The layered body used in the method for producing an optical film according to the present invention includes a resin layer, and a laser absorption layer disposed on one surface of the resin layer. In the following description, this specific resin layer is sometimes referred to as a “resin layer (R)” for distinguishing from general resin layers.

In a preferable example, the layered body is subjected to the cutting step as a composite with a support. Specifically, a support-layered body composite including the support, the laser absorption layer, and the resin layer (R) in this order may be subjected to the cutting step.

[2.1. Support]

Examples of a material constituting the support may include glass, resin, and metal. Specific examples of the glass may include soda glass, lead glass, borosilicate glass, non-alkali glass, quartz glass, and chemically strengthened glass. Examples of the resin may include a resin that may have heat resistance such as a polyimide resin and a polyethylene naphthalate resin. Examples of the metal may include aluminum and stainless steel.

The thickness of the support is not particularly limited, and a thickness suitable for carrying out the method of the present invention may be appropriately selected. For example, when the support is formed of glass, the thickness thereof is specifically preferably 0.05 mm or more, and more preferably 0.3 mm or more, and is preferably 1.3 mm or less, and more preferably 1.1 mm or less. When the support is formed of a resin, the thickness thereof is specifically preferably 0.005 mm or more, and more preferably 0.01 mm or more, and is preferably 0.2 mm or less, and more preferably 0.1 mm or less. When the support is formed of metal, the thickness thereof is specifically preferably 0.005 mm or more, and more preferably 0.01 mm or more, and is preferably 2.0 mm or less, and more preferably 1.0 mm or less.

[2.2. Resin Layer (R)]

The resin layer (R) contains a resin as a main component, and is a layer to be cut in the cutting step of the method for producing an optical film of the present invention. The resin layer (R) may be formed of a single layer or a plurality of layers. In a preferable aspect, the resin layer (R) may be formed only of a transparent resin layer formed of a transparent resin, or may be formed of a plurality of layers including such a transparent resin layer and an optional layer.

[2.2.1. Transparent Resin Layer]

As the resin constituting the transparent resin layer, any resin that may be used as a material of the optical film may be used. As such a resin, a resin excellent in desired properties such as transparency, mechanical strength, thermal stability, moisture shielding property and the like may be appropriately selected. Examples of such resins may include an acetate resin such as triacetyl cellulose, a polyester resin, a polyether sulfone resin, a polycarbonate resin, a polyamide resin, a polyimide resin, a polyolefin resin, a cyclic olefin resin, and a (meth)acrylic resin. Among these, an acetate resin, a cyclic olefin resin, and a (meth)acrylic resin are preferable in terms of small birefringence, and a cyclic olefin resin is particularly preferable from the viewpoint of transparency, low hygroscopicity, size stability, and light weight properties.

[2.2.2. Olefin Resin Layer]

In a preferable aspect, one or more of the transparent resin layers that the resin layer (R) includes is an olefin resin layer. The olefin resin constituting the olefin resin layer is a thermoplastic resin containing a cyclic olefin polymer. The olefin resin layer is useful in optical applications such as a polarizer protective layer from various viewpoints such as transparency, low hygroscopicity, size stability, and light weight properties. However, since the olefin resin has little absorption of laser light, it is difficult to satisfactorily cut the olefin resin layer by laser light without damaging the support. To address this issue, by subjecting the resin layer (R) having the olefin resin layer to the production method of the present invention, cutting with laser light can be smoothly and favorably performed while useful performance of the olefin resin layer is enjoyed.

[2.2.3. Cyclic Olefin Polymer]

The cyclic olefin polymer is a polymer having an alicyclic structure as a structural unit of the polymer. The resin containing such a cyclic olefin polymer is usually excellent in properties such as transparency, size stability, phase difference expression properties, and properties of facilitating molding at low temperature.

The cyclic olefin polymer may be a polymer containing an alicyclic structure in a main chain, a polymer containing an alicyclic structure in a side chain, a polymer containing an alicyclic structure in a main chain and a side chain, and mixtures of two or more of these at any ratio. Among these, a polymer containing an alicyclic structure in its main chain is preferable from the viewpoint of mechanical strength and heat resistance.

Examples of the alicyclic structure may include a saturated alicyclic hydrocarbon (cycloalkane) structure, and an unsaturated alicyclic hydrocarbon (cycloalkene, cycloalkyne) structure. Among these, a cycloalkane structure and a cycloalkene structure are preferable from the viewpoint of mechanical strength and heat resistance. A cycloalkane structure is particularly preferable among these.

The number of carbon atoms constituting the alicyclic structure is preferably 4 or more, and more preferably 5 or more, and is preferably 30 or less, more preferably 20 or less, and particularly preferably 15 or less, per alicyclic structure. When the number of carbon atoms constituting the alicyclic structure falls within this range, mechanical strength, heat resistance, and moldability of the cyclic olefin resin are highly balanced.

The ratio of the structural unit having an alicyclic structure in the cyclic olefin polymer may be selected according to the intended use of the obtained products. The ratio of the structural unit having an alicyclic structure in the cyclic olefin polymer is preferably 55% by weight or more, more preferably 70% by weight or more, and particularly preferably 90% by weight or more. When the ratio of the structural unit having an alicyclic structure in the cyclic olefin polymer falls within this range, the cyclic olefin resin has good transparency and heat resistance.

Among cyclic olefin polymers, a cycloolefin polymer is preferable. The cycloolefin polymer is a polymer having a structure obtained by polymerizing a cycloolefin monomer. The cycloolefin monomer has a ring structure formed by carbon atoms and is a compound having a polymerizable carbon-carbon double bond in the ring structure. Examples of the polymerizable carbon-carbon double bonds may include carbon-carbon double bonds capable of polymerization such as ring-opening polymerization. Examples of the cyclic structure of the cycloolefin monomer may include a monocyclic structure, a polycyclic structure, a condensed polycyclic structure, a bridged ring structure, and a polycyclic structure obtained by combining these. Among these, a polycyclic cycloolefin monomer is preferable from the viewpoint of highly balancing the properties such as dielectric properties and heat resistance of the obtained polymer.

Examples of the preferable cycloolefin polymer may include a norbornene-based polymer, a monocyclic olefin-based polymer, a cyclic conjugated diene-based polymer, and hydrogenated products thereof. Among these, a norbornene-based polymer is most preferable because of good moldability.

Examples of the norbornene-based polymer may include a ring-opening polymer of a monomer having a norbornene structure and a hydrogenated product thereof; and an addition polymer of a monomer having a norbornene structure and a hydrogenated product thereof. Examples of the ring-opening polymer of a monomer having a norbornene structure may include a ring-opening homopolymer of one type of monomer having a norbornene structure, a ring-opening copolymer of two or more types of monomers having a norbornene structure, and a ring-opening copolymer of a monomer having a norbornene structure and another monomer copolymerizable therewith. Further, examples of the addition polymer of a monomer having a norbornene structure may include an addition homopolymer of one type of monomer having a norbornene structure, an addition copolymer of two or more types of monomers having a norbornene structure, and an addition copolymer of a monomer having a norbornene structure and another monomer copolymerizable therewith. Among these, a hydrogenated product of a ring-opening polymer of a monomer having a norbornene structure is particularly suitable from the viewpoint of moldability, heat resistance, low hygroscopicity, size stability, and light weight properties.

Examples of the monomer having a norbornene structure may include bicyclo[2.2.1]hept-2-ene (common name: norbornene), tricyclo[4.3.0.1^{2,5}]deca-3,7-diene (common name: dicyclopentadiene), 7,8-benzotricyclo[4.3.0.1^{2,5}]dec-3-ene (common name: methanotetrahydrofluorene), tetracyclo[4.4.0.1^{2,5}0.1^{7,10}]dodeca-3-ene (common name: tetracyclododecene), and derivatives of these compounds (for example, those with a substituent on the ring). Examples of the substituent may include an alkyl group, an alkylene group, and a polar group. A plurality of these substituents that may be the same as or different from each other may be bonded to the ring. As the monomer having a norbornene structure, one type thereof may be solely used, and two or more types thereof may also be used in combination at any ratio.

Examples of the polar group may include a heteroatom, and an atomic group having a heteroatom. Examples of the heteroatom may include an oxygen atom, a nitrogen atom, a sulfur atom, a silicon atom, and a halogen atom. Specific examples of the polar group may include a carboxyl group, a carbonyloxycarbonyl group, an epoxy group, a hydroxyl group, an oxy group, an ester group, a silanol group, a silyl group, an amino group, an amido group, an imido group, a nitrile group, and a sulfonic acid group.

Examples of a monomer that is ring-opening copolymerizable with the monomer having a norbornene structure may include monocyclic olefins such as cyclohexene, cycloheptene, and cyclooctene, and derivatives thereof; and cyclic conjugated dienes such as cyclohexadiene and cycloheptadiene, and derivatives thereof. As the monomer that is ring-opening copolymerizable with the monomer having a norbornene structure, one type thereof may be solely used, and two or more types thereof may also be used in combination at any ratio.

The ring-opening polymer of the monomer having a norbornene structure may be produced, for example, by polymerizing or copolymerizing the monomer in the presence of a ring-opening polymerization catalyst.

Examples of a monomer that is addition copolymerizable with the monomer having a norbornene structure may include α-olefins of 2 to 20 carbon atoms such as ethylene, propylene, and 1-butene, and derivatives thereof; cycloolefins such as cyclobutene, cyclopentene, and cyclohexene, and derivatives thereof; and non-conjugated dienes such as 1,4-hexadiene, 4-methyl-1,4-hexadiene, and 5-methyl-1,4-hexadiene. Among these, α-olefin is preferable, and ethylene is more preferable. As the monomer that is addition copolymerizable with the monomer having a norbornene structure, one type thereof may be solely used, and two or more types thereof may also be used in combination at any ratio.

The addition polymer of the monomer having a norbornene structure may be produced, for example, by polymerizing or copolymerizing the monomer in the presence of an addition polymerization catalyst.

The above-mentioned hydrogenated products of the ring-opening polymer and the addition polymer may be produced, for example, by hydrogenating an unsaturated carbon-carbon bond, preferably 90% or more thereof, in a solution of the ring-opening polymer and the addition polymer. The hydrogenation may be performed in the presence of a hydrogenation catalyst containing a transition metal such as nickel, palladium, or the like.

Among the norbornene-based polymers, it is preferable that the polymer has an X: bicyclo[3.3.0]octane-2,4-diyl-ethylene structure and a Y: tricyclo[4.3.0.1^{2,5}]decane-7,9-diyl-ethylene structure as structural units, and that the amount of these structural units is 90% by weight or more relative to the entire structural unit of the norbornene-based polymer, and the content ratio of X and Y is 100:0 to 40:60 by weight ratio of X:Y. By using such a polymer, the olefin resin layer containing the norbornene-based polymer can be made to have excellent stability of optical properties without size change over a long period of time.

Examples of the monocyclic olefin polymers may addition polymers of a cyclic olefin monomer having a single ring such as cyclohexene, cycloheptene, cyclooctene or the like.

Examples of the cyclic conjugated diene-based polymer may include a polymer obtained by cyclizing reaction of an addition polymer of a conjugated diene-based monomer such as 1,3-butadiene, isoprene, chloroprene, or the like; and 1,2- or 1,4-addition polymers of a cyclic conjugated diene-based monomer such as cyclopentadiene, cyclohexadiene or the like; and hydrogenated products thereof.

Furthermore, it is preferable that the molecule of the aforementioned cyclic olefin polymer does not contain a polar group. A cyclic olefin polymer containing no polar group in the molecule generally has particularly low tendency to absorb carbon dioxide laser light. However, according to the production method of the present invention, the resin layer (R) containing such a cyclic olefin polymer containing no polar group in the molecule can also be easily cut with laser light. Further, when a cyclic olefin polymer containing no polar group in the molecule is used, water absorption of the transparent resin layer in the obtained polarizing plate can be reduced.

The weight-average molecular weight (Mw) of the cyclic olefin polymer may be appropriately selected according to the intended use of the obtained products, and is preferably 10,000 or more, more preferably 15,000 or more, and particularly preferably 20,000 or more, and is preferably 100,000 or less, more preferably 80,000 or less, and particularly preferably 50,000 or less. When the weight-average molecular weight falls within this range, mechanical strength and molding processability of the transparent resin layer in the obtained product are highly balanced. Here, the weight-average molecular weight described above is a polyisoprene- or polystyrene-equivalent weight-average molecular weight measured by gel permeation chromatography using cyclohexane as a solvent (when the sample is not dissolved in cyclohexane, toluene may be used as the solvent).

The molecular weight distribution (weight-average molecular weight (Mw)/number-average molecular weight (Mn)) of the cyclic olefin polymer is preferably 1.2 or more, more preferably 1.5 or more, and particularly preferably 1.8 or more, and is preferably 3.5 or less, more preferably 3.0 or less, and particularly preferably 2.7 or less. When the molecular weight distribution is equal to or more than the lower limit value of the aforementioned range, productivity of the polymer can be enhanced and production cost can be suppressed. When the molecular weight distribution is equal to or less than the upper limit value thereof, the amount of the low molecular weight component becomes small, and the relaxation at the time of high temperature exposure can be suppressed, whereby stability of the transparent resin layer can be enhanced.

The ratio of the cyclic olefin polymer in the olefin resin layer is preferably 90% by weight or more, more preferably 92% by weight or more, and particularly preferably 95% by weight or more, and is preferably 99.9% by weight or less, more preferably 99% by weight or less, and particularly preferably 98% by weight or less. When the ratio of the cyclic olefin polymer is equal to or more than the lower limit value of the aforementioned range, water absorbability of the transparent resin layer can be reduced. When the ratio of the cyclic olefin polymer is equal to or less than the upper limit value of the aforementioned range, the absorbance of light at wavelength of 9 μm to 11 μm can be increased, so that the resin layer can be easily cut with carbon dioxide laser light.

The olefin resin layer may further contain an optional component in addition to the cyclic olefin polymer. Examples of the optional components may include an ester compound for enhancing the sensitivity to laser light, a colorant such as a pigment and a dye; a fluorescent brightener; a dispersant; a heat stabilizer; a light stabilizer; an ultraviolet absorber; an antistatic agent; an antioxidant; a microparticle; and a surfactant. Among these components, one type thereof may be solely used, and two or more types thereof may also be used in combination at any ratio.

The glass transition temperature of the cyclic olefin polymer forming the olefin resin layer is preferably 100° C. or higher, more preferably 110° C. or higher, and particularly preferably 120° C. or higher, and is preferably 190° C. or lower, more preferably 180° C. or lower, and particularly preferably 170° C. or lower. When the glass transition temperature falls within the aforementioned range, a transparent resin layer having excellent durability can be easily produced. When the glass transition temperature thereof is equal to or lower than the upper limit value, molding is facilitated.

[2.2.4. Thickness, Properties, and the Like of Transparent Resin Layer]

The thickness T_{R} of the transparent resin layer is 1 or more, more preferably 5 μm or more, and particularly preferably 10 μm or more, and is preferably 100 μm or less, more preferably 50 μm or less, and particularly preferably 30 μm or less. When the thickness of the transparent resin layer is equal to or more than the lower limit value of the aforementioned range, properties to achieve efficient absorption of carbon dioxide laser light can be imparted to the transparent resin layer. When the thickness is equal to or less than the upper limit value thereof, haze of the transparent resin layer can be lowered, so that the transparency of the transparent resin layer can be made favorable.

The transparent resin layer being “transparent” means that the transparent resin layer has a light transmittance of a degree suitable for use in a polarizing plate. In the present invention, the sum of the total light transmittances of one or more transparent resin layers in the resin layer (R) may be 80% or more.

[2.3. Laser Absorption Layer]

The laser absorption layer is a layer having a larger absorbance of light at a specific wavelength than that of the resin layer. That is, the average absorbance A_{A} of light in a wavelength range of 9 μm or more and 11 μm or less by the laser absorption layer is larger than the average absorbance A_{R} of light in the wavelength range of 9 μm or more and 11 μm or less by the resin layer. The difference A_{A}-A_{R} between the average absorbances A_{A} and A_{R} is preferably 0.02 or more, and more preferably 0.03 or more.

As described herein, the absorbance of light in a certain layer is a ratio of the intensity reduced by the passing through the layer wherein the light having entered the layer passes through and exits the layer, relative to the intensity of incident light. In the present application, the ratio is represented by a relative value based on the premise that the intensity of incident light is 1. The average absorbance is obtained by performing measurement using, for example, NICOLET iS5 (Thermo Fisher Scientific Inc.) as a measuring device, by a transmission method with a detector DTGS KBr having a resolution of 4 cm⁻¹ and with number of integrations of 16 times, and calculating the average value of the absorbance in a wavelength region of 9 μm or more and 11 μm or less.

The average absorbance A_{A} of the laser absorption layer is preferably a value equal to or higher than a certain degree. Specifically, the average absorbance may be preferably 0.07 or more, and more preferably 0.1 or more. The upper limit of the average absorbance A_{A} of the laser absorption layer is not particularly limited, but may be, for example, 4.0 or less. On the other hand, the average absorbance A_{R} of the resin layer (R) may be, for example, 0.02 to 0.05. In the production method of the present invention, even when the average absorbance A_{R} of the resin layer (R) is such a low value, smooth cutting can be performed.

Since the laser absorption layer has the above-mentioned absorbance, the resin layer (R) can be smoothly cut in the cutting step. Specifically, the laser absorption layer absorbs the energy of the laser to generate heat, and the heat is transferred to the resin layer (R), thereby promoting the cutting of the resin layer (R).

The laser absorption layer has a thickness in a specific ratio relative to the thickness of the resin layer. That is, the ratio T_{A}/T_{R} of the thickness T_{A} of the laser absorption layer relative to the thickness T_{R} of the resin layer is 0.8 or more. The ratio T_{A}/T_{R} is preferably 0.9 or more, and more preferably 1.0 or more. On the other hand, the upper limit of the ratio T_{A}/T_{R} is not particularly limited, but may be 50 or less. When the ratio T_{A}/T_{R} is equal to or more than the above-mentioned lower limit, the laser absorption layer generates sufficient heat to sufficiently promote the cutting of the resin layer (R). On the other hand, when the ratio T_{A}/T_{R} is equal to or less than the upper limit, the resin layer (R) can be smoothly bonded and peeled off.

The thickness T_{A} of the laser absorption layer preferably falls within a specific range from the viewpoint of providing good adhesion and ability to promote cutting. Specifically, T_{A} is preferably 10 μm or more, and more preferably 20 μm or more, and is preferably 50 μm or less, and more preferably 40 μm or less.

Preferably, the laser absorption layer is a layer of a resin containing an ester compound. An ester compound is a compound having an ester bond in its molecule. When containing the ester compound, the laser absorption layer can efficiently absorb the energy of laser light in a wavelength range of 9 μm or more and 11 μm or less.

Preferably, the laser absorption layer is an adhesive layer. When the laser absorption layer is an adhesive layer, the formation of a support-layered body composite can be facilitated.

More preferably, the resin containing an ester compound in the laser absorption layer is an acrylic adhesive. The acrylic adhesive is an adhesive containing an acrylic polymer. Examples of the acrylic polymers may include a polymer of an acrylic monomer and a copolymer of an acrylic monomer and other optional monomers.

Examples of the acrylic monomer may include alkyl (meth)acrylates, alkoxyalkyl (meth)acrylates, (meth)acrylamides, and combinations thereof. Examples of the alkyl (meth)acrylates may include methyl (meth)acrylate, ethyl (meth)acrylate, n-butyl (meth)acrylate, 2-ethylhexyl (meth)acrylate, isobutyl (meth)acrylate, hexyl (meth)acrylate, octyl (meth)acrylate, lauryl (meth)acrylate, stearyl (meth)acrylate, and combinations thereof.

Examples of the alkoxyalkyl (meth)acrylates may include methoxyethyl (meth)acrylate, butoxyethyl (meth)acrylate, and combinations thereof.

Examples of the (meth)acrylamides may include cyclohexyl (meth)acrylate, phenyl (meth)acrylate, benzyl (meth)acrylate, vinyl acetate, (meth)acrylamide, N-methylol(meth)acrylamide, and combinations thereof.

The acrylic polymer may be a copolymer of the acrylic monomer described above and an acrylic monomer having a functional group. Examples of the acrylic monomers having a functional group may include unsaturated acids such as maleic acid, fumaric acid, and (meth)acrylic acid; 2-hydroxyethyl (meth)acrylate, 2-hydroxypropyl (meth)acrylate, 2-hydroxyhexyl (meth)acrylate, dimethylaminoethyl methacrylate, (meth)acrylamide, N-methylol(meth)acrylamide, glycidyl (meth)acrylate, and maleic anhydride. As the acrylic monomers having a functional group, one type thereof may be solely used, and two or more types thereof may also be used in combination at any ratio.

The acrylic adhesive may include a crosslinking agent as necessary. The crosslinking agent is a compound for causing thermal cross-linking reaction with a functional group present in the copolymer and finally forming a layer having a three-dimensional network structure. When the acrylic adhesive includes such a crosslinking agent, adhesion of the protective film to other layers in contact with the acrylic adhesive, and toughness, solvent resistance, water resistance, and the like of the protective film can be improved. Examples of the crosslinking agents may include an isocyanate-based compound, a melamine-based compound, a urea-based compound, an epoxy-based compound, an amino-based compound, an amide-based compound, an aziridine compound, an oxazoline compound, a silane coupling agent, and modified products thereof. As the crosslinking agents, one type thereof may be solely used, and two or more types thereof may also be used in combination at any ratio.

From the viewpoint of crosslinkability and toughness of the adhesive layer, it is preferable to use an isocyanate-based compound and a modified product thereof as the crosslinking agent. The isocyanate-based compound is a compound having two or more isocyanate groups in one molecule, and is roughly classified into an aromatic compound and an aliphatic compound. Examples of the aromatic isocyanate-based compound may include tolylene diisocyanate, diphenylmethane diisocyanate, polymethylene polyphenyl polyisocyanate, naphthalene diisocyanate, tolidine diisocyanate, and paraphenylene diisocyanate. Examples of the aliphatic isocyanate-based compound may include hexamethylene diisocyanate, isophorone diisocyanate, dicyclohexylmethane diisocyanate, hydrogenated xylylene diisocyanate, lysine diisocyanate, tetramethylxylene diisocyanate, and xylylene diisocyanate. Further, examples of the modified products of these isocyanate-based compounds may include a biuret form, an isocyanurate form, a trimethylolpropane adduct form, and the like of the isocyanate-based compounds.

When the acrylic adhesive contains a crosslinking agent, the acrylic adhesive may further contain a crosslinking catalyst such as dibutyltin laurate, to promote the cross-linking reaction.

The acrylic adhesive may contain a tackifying polymer as necessary. Examples of the tackifying polymers may include an aromatic hydrocarbon polymer, an aliphatic hydrocarbon polymer, a terpene polymer, a terpene phenolic polymer, an aromatic hydrocarbon modified terpene polymer, a coumarone indene polymer, a styrene-based polymer, a rosin-based polymer, a phenol-based polymer, and a xylene polymer, among which an aliphatic hydrocarbon polymer such as low density polyethylene is preferable. However, the specific type of the tackifying polymer is appropriately selected in terms of compatibility with other polymers, melting point of the resin, and tackiness of the acrylic adhesive. As the tackifying polymer, one type thereof may be solely used, and two or more types thereof may also be used in combination at any ratio.

The amount of the tackifying polymer is preferably 5 parts by weight or more, and preferably 200 parts by weight or less, and more preferably 100 parts by weight or less, relative to 100 parts by weight of the acrylic adhesive. When the amount of the tackifying polymer is equal to or more than the lower limit value of the aforementioned range, the protective film can be prevented from floating or peeling off when it is bonded to the cyclic polyolefin film. When the amount is equal to or less than the upper limit value, it is possible to suppress the unwinding tension of the protective film, to prevent wrinkles and scratches at the time of bonding with the cyclic polyolefin film, and to prevent bleed-out of the tackifying polymer for maintaining high tackiness of the acrylic adhesive.

The acrylic adhesive may contain additives such as a softener, an anti-aging agent, a filler, and a colorant (such as a dye or a pigment), as necessary. As the additives, one type thereof may be solely used, and two or more types thereof may also be used in combination at any ratio.

[2.4. Method for Preparing Layered Body and Support-Layered Body Composite]

The method for preparing the layered body and the support-layered body composite is not particularly limited, and any method may be adopted. In a preferable example, a support-layered body composite in which a layered body is provided on a support may be easily prepared by preparing an adhesive capable of forming a laser absorption layer and bonding the resin layer (R) and the support using the adhesive.

[3. Cutting Step]

The method for producing an optical film according to the present invention includes a cutting step of irradiating the layered body with laser light to cut the resin layer (R) of the layered body.

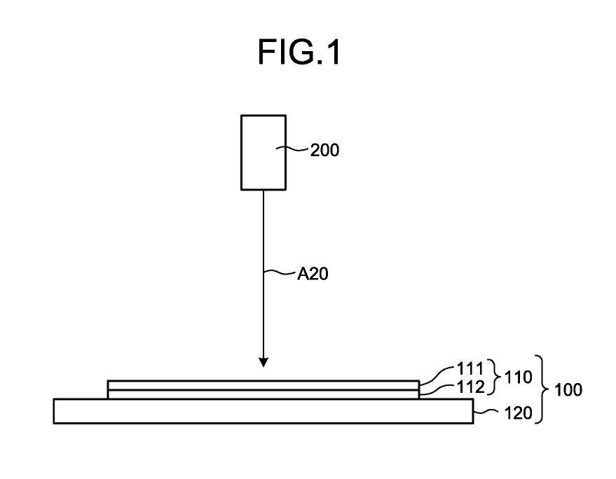

The cutting step in the present invention will be described with reference to the drawings. FIG. 1 is a side view illustrating an example of a positional relationship between the support-layered body composite and laser light in the cutting step in the method for producing an optical film according to the present invention. In this example, a support-layered body composite 100 includes a layered body 110 and a support 120. The layered body 110 includes a resin layer (R) 111 and a laser absorption layer 112. The laser absorption layer 112 functions as an adhesive layer to bond the resin layer (R) 111 and the support 120.

In this example, the support-layered body composite 100 is horizontally placed with the surface on the resin layer (R) 111 side facing upward. A laser light irradiation device 200 is disposed above the support-layered body composite 100. From the laser light irradiation device 200, laser light is emitted in a vertically downward direction indicated by an arrow A20 to irradiate the surface of the support-layered body composite 100 on the resin layer (R) 111 side with laser light. However, an actual cutting step is not limited to this example. The layered body may be placed in any optional direction, and irradiation of the laser light may be performed from any appropriate optional direction.

In the cutting step, as illustrated in the example of FIG. 1, it is preferable that the irradiation with laser light is performed on the resin layer (R) side of the support-layered body composite. Accordingly, the laser light having entered the resin layer (R) sequentially passes through the resin layer (R) and the laser absorption layer, and, if the support is light transmissible, further passes through the support. At this time, the energy of the laser light is sequentially absorbed by the resin layer (R) and the laser absorption layer. Here, even when the energy absorbed by the resin layer (R) is small, the energy thereafter absorbed by the laser absorption layer is large. Therefore, a large amount of heat is generated in the laser absorption layer, and a part thereof is conducted to the resin layer (R). Thus, even when the resin layer (R) is low in the sensitivity to a laser, the cutting of the resin layer (R) can be achieved with a relatively low power of laser light. Furthermore, even when the laser absorption layer is disposed on both sides of the resin layer (R), the cutting of the resin layer (R) can be achieved. Consequently, the cutting of the resin layer (R) can be smoothly performed without damaging the support.

The energy distribution of a beam of laser light in the cutting step is not particularly limited, and may be a Gaussian-mode energy distribution that is emitted from a commonly used laser light irradiation device, or may be a flat-shape energy distribution. However, the flat-shape energy distribution is preferable. The beam having the flat-shape energy distribution is also called a “top hat”-shape beam.

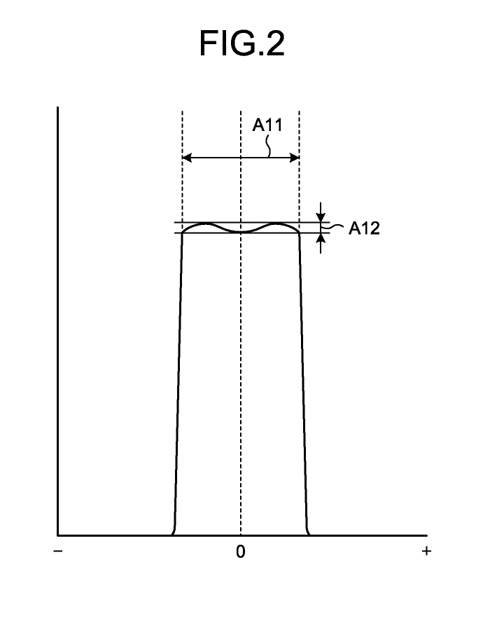

The energy distribution of a beam may be expressed by a graph in which the horizontal axis indicates a distance from the optical axis of a beam, and the vertical axis indicates an energy amount in the position at the distance. An example of the flat-shape energy distribution will be described with reference to FIG. 2. FIG. 2 is a graph illustrating an example of an energy distribution of a beam of certain laser light having a flat-shape energy distribution. The horizontal axis of FIG. 2 indicates a distance from the optical axis of a beam of laser light with a certain azimuth angle indicated as the positive and the opposite azimuth angle indicated as the negative. The vertical axis of FIG. 2 indicates the energy amount of laser light at the position of the distance. In the example shown in FIG. 2, the energy distribution has a flat shape in a width indicated by an arrow A11. The laser light exhibiting such a flat-shape energy distribution in at least one azimuth may be used in the cutting step. For example, a beam having a flat-shape energy distribution in all azimuth angles in a cross section perpendicular to the optical axis of a beam may be used. Alternatively, a beam having a top hat-shape energy distribution in the major axis direction of the cross section of a beam and a Gaussian distribution in the minor axis direction may also be used.

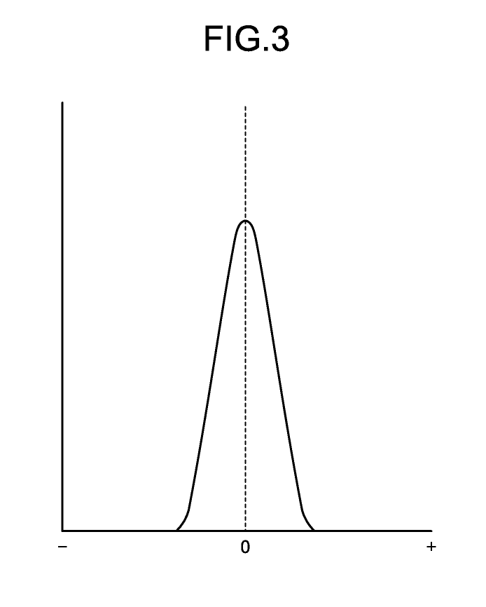

On the other hand, FIG. 3 is a graph showing an example of an energy distribution of a beam of Gaussian-mode laser light that is commonly used in prior art. In the example shown in FIG. 3, the energy distribution has a shape without a flat portion.

In a preferable example, the fluctuation of the energy amount (corresponding to an arrow A12 in FIG. 2) in a flat region relative to the average energy amount in the flat region is preferably ±10%, more preferably ±7%, and further more preferably ±6%. With laser light having such an energy distribution, the resin layer (R) can be more reliably cut while the damage to the support is further reduced. In addition, even when the laser absorption layer is relatively thin, the damage to the support can be further reduced, and the cutting can be further smoothly performed.

A beam having such a flat-shape energy distribution may be obtained by disposing a beam shaper in a path of a common beam emitted in a Gaussian mode or a mode close to a Gaussian mode, to thereby convert the energy distribution. Examples of the beam shaper may include a shaper which shapes an incident beam by refraction, diffraction, reflection, and a combination thereof to reallocate the energy distribution in the beam. More specific examples of the beam shaper may include any known beam shaper, such as those described in Patent Literatures 2 and 3. Another example of the beam shaper may include a commercially available shaper (for example, a top hat module manufactured by DAICO MFG CO., LTD) which converts a Gaussian beam into a beam having a flat energy distribution in at least one azimuth.

The laser device used in the cutting step may be selected from various types of laser devices which may be used for the processing of a film. Examples of the usable laser device may include a carbon dioxide laser device. The carbon dioxide laser device is preferable, because it is relatively less expensive among various laser devices, and a wavelength and output power suitable for the processing of a film are efficiently obtained.

The wavelength of the laser light emitted from the laser device in the cutting step may be 9 μm or more and 11 μm or less. In particular, laser light having a wavelength around 9.4 μm (9.1 to 9.7 μm) and around 10.6 μm (10.1 to 11.0 μm) can be stably output when a carbon dioxide laser device is used as the laser device. Therefore, when laser light having such a wavelength is adopted, the production method according to the present invention can be favorably performed.

The output P of the laser light is preferably 1 W or higher, more preferably 5 W or higher, and further preferably 15 W or higher, and is preferably 400 W or lower, more preferably 350 W or lower, further preferably 300 W or lower, still further preferably 250 W or lower, and particularly preferably 120 W or lower. When the output P of the laser light is equal to or higher than the lower limit value of the aforementioned range, the amount of irradiation of the laser light can be prevented from being insufficient, and the cutting step can be stably performed. When the output P of the laser light is equal to or lower than the upper limit value of the aforementioned range, undesirable deformation of the film and damage to the support can be suppressed.

The laser light may be continuous laser light or pulsed laser light. Among them, pulsed laser light is preferable. By using pulsed laser light, processing can be performed while suppressing heat generation.

When pulsed laser light is used, the frequency of the laser light is preferably 10 kHz or more, more preferably 15 kHz or more, and particularly preferably 20 kHz or more, and is preferably 300 kHz or less, more preferably 200 kHz or less, further preferably 150 kHz or less, and particularly preferably 80 kHz or less. When the frequency of the pulsed laser light is equal to or more than the lower limit value of the aforementioned range, processing speed can be increased. When the frequency is equal to or lower than the upper limit value, processing in which the influence of heat is further suppressed can be performed.

When pulsed laser light is used, the range of the pulse width is preferably 10 nanoseconds or more, more preferably 12 nanoseconds or more, and particularly preferably 15 nanoseconds or more, and is preferably 30 nanoseconds or less, more preferably 28 nanoseconds or less, and particularly preferably 25 nanoseconds or less. When the pulse width of the pulsed laser light is equal to or more than the lower limit value of the aforementioned range, processing speed can be increased. When the frequency is equal to or lower than the upper limit value, processing in which the influence of heat is further suppressed can be performed.

In the cutting step, irradiation of the resin layer (R) with laser light is usually performed so that the laser light scans the surface of the resin layer (R) along a desired line. By such a scanning, the point at which laser light hits the resin layer (R) moves along the desired line on the surface of the resin layer (R), so that the resin layer (R) can be cut into a desired shape to be cut. Upon scanning, in order to cause the laser light to scan the surface of the resin layer (R), the laser irradiation device may be moved, the resin layer (R) may be moved, or both the laser light and the resin layer (R) may be moved.

The scanning speed, that is, the moving speed of a point at which laser light hits the resin layer (R) when the point moves on the surface of the resin layer (R), may be adequately set depending on conditions such as the output power P of laser light, the thickness of the resin layer (R), and the like. The specific range of the scanning speed V is preferably 5 mm/s or more, more preferably 10 mm/s or more, and particularly preferably 20 mm/s or more, and is preferably 4000 mm/s or less, more preferably 3000 mm/s or less, further more preferably 2000 mm/s or less, and particularly preferably 1500 mm/s or less. When the scanning speed V is equal to or more than the lower limit value of the aforementioned range, generation of heat can be suppressed, and a favorable cut surface can be obtained. When the scan rate V is equal to or less than the upper limit value, the number of scans of laser light can be reduced, and efficient cutting is enabled.

The irradiation with laser light is preferably performed such that the ratio P/V between the output power P of laser light (unit: W) and the scanning speed V (unit: mm/s) becomes within a specific range.

The value of P/V is 0.10 or more, and preferably 0.15 or more, and is 0.25 or less, and preferably 0.20 or less. When irradiation with such laser light is performed in the cutting step, the damage to the support can be further reduced, and the cutting of the resin layer can be further smoothly performed.

When irradiation with laser light is performed for cutting the resin layer (R) along a certain line, the number of scans of laser light along the line may be once, or may be twice or more. When cutting is performed by one scan, the time required for the cutting step can be shortened. When the cutting is performed by two or more scans, the heat generated in the resin layer (R) per one irradiation with laser light can be reduced, thereby further decreasing the width of an area affected by laser treatment.

When the laser light exhibiting a flat-shape energy distribution only in one azimuth is used as laser light, scanning with laser light in a direction vertical to the azimuth in the cutting step is preferable, because a precisely controlled cut surface can thereby be obtained.

[4. Process after Cutting Step]

In the method for producing an optical film according to the present invention, an optional step may be performed after the cutting step. An example of the optional step may be a step of peeling from the support a portion or entirety of the resin layer (R) which has become a plurality of film pieces as a result of the cutting step. In peeling, all of the layers of the resin layer (R) may be entirely peeled from the support, or only a part of the layers may be peeled from the remainder. The peeled film piece of the resin layer (R) may be used as an optical film to serve as a product, as it is or through an optional step such as bonding to another optional layer as necessary. Alternatively, the layered body containing the cut film piece of the resin layer (R) and the support as it is may be incorporated into a display device, as a layered body containing a combination of a polarizing plate and a support which serves as a product.

The use applications of the optical film obtained by the production method according to the present invention is not particularly limited, and may be any optical member such as a polarizing plate. This optical film may be used solely, or may be used in combination with another optional member. For example, the optical film may be incorporated into a display device such as a liquid crystal display device, an organic electroluminescent display device, a plasma display device, an FED (field emission display) display device, and an SED (surface-conduction electron-emitter display) display device.

As another example, the film piece of the optical film obtained by the method for producing an optical film according to the present invention may be used as a protective film for a polarizer to be further bonded to another polarizer layer, so as to constitute a polarizing plate.

Furthermore, for example, the obtained film piece as a phase difference film may be combined with a circularly polarizing film to obtain a brightness enhancing film.

### EXAMPLE

Hereinafter, the present invention will be specifically described by illustrating Examples. However, the present invention is not limited to the Examples described below. The present invention may be optionally modified for implementation without departing from the scope of claims of the present invention and the scope of their equivalents.

In the following description, “%” and “part” representing quantity are on the basis of weight, unless otherwise specified. The operation described below was performed under the conditions of normal temperature and normal pressure, unless otherwise specified.

[Evaluation Methods]

(Measurement of Average Absorbance)

The resin films obtained in Examples and Comparative Examples were each prepared as a sample 1. On one surface of the sample 1, an adhesive layer made of the same material and having the same thickness as those of the adhesive layer used in each of Examples and Comparative Examples was further disposed to prepare a sample 2. These samples 1 and 2 were measured for average absorbance. The average absorbance was obtained by performing measurement using NICOLET iS5 (Thermo Fisher Scientific Inc.) as a measuring device, by a transmission method with a detector DIGS KBr, a resolution of 4 cm⁻¹, and the number of integrations of 16 times, and calculating the average value of the absorbance in a wavelength region of 9 μm or more and 11 μm or less. The average absorbance of the sample 1 was adopted as average absorbance A_{R}. The difference between the average absorbance of the sample 2 and the average absorbance of the sample 1 was adopted as average absorbance A_{A}. The average absorbance A_{R} of each of Examples and Comparative Examples was as shown in the following Table 1 and Table 2. It was confirmed that the average absorbance A_{A} was far larger than 0.07 in all of Examples and Comparative Examples.

### Example 1

(1-1. Cyclic Olefin Resin Film)

To a nitrogen-substituted reaction vessel, 7 parts of a mixture of tricyclo [4.3.0.1^{2,5}] deca-3-ene (hereinafter referred to as “DCP”), tetracyclo [4.4.0.1^{2,5}.1^{7,10}] dodeca-3-ene (hereinafter referred to as “TCD”), and tetracyclo [9.2.1.0^{2,10}.0^{3,8}] tetradeca-3,5,7,12-tetraene (hereinafter referred to as “MTF”) (weight ratio of 60/35/5) (1% by weight relative to the entire amount of monomers used in polymerization) and 1600 parts by weight of cyclohexane were added. 0.55 Part of tri-i-butylaluminum, 0.21 part of isobutyl alcohol, 0.84 part of diisopropyl ether as a reaction adjuster, and 3.24 parts of 1-hexene as a molecular weight adjuster were added. To this, 24.1 parts of a 0.65% tungsten hexachloride solution dissolved in cyclohexane was added and stirred at 55° C. for 10 minutes. Then, 693 parts of a mixture of DCP, TCD, and MTF (weight ratio of 60/35/5) and 48.9 parts of a 0.65% tungsten hexachloride solution dissolved in cyclohexane were continuously added dropwise into the reaction system over 150 minutes while the system was maintained at 55° C. After that, the reaction was continued for 30 minutes and thereafter the polymerization was terminated. As a result, a ring-opening polymerization reaction liquid was obtained.

After the polymerization, the polymerization conversion of the monomer measured by gas chromatography was 100% at the end of the polymerization.

The obtained ring-opening polymerization reaction liquid was transferred to a pressure-resistant hydrogenation reaction vessel. 1.4 parts of a diatomaceous earth-supported nickel catalyst (manufactured by Nikki Chemical Co., Ltd., product name “T8400 RL”, nickel carrying ratio: 57%) and 167 parts of cyclohexane were added thereto, and reaction was performed at 180° C. and hydrogen pressure of 4.6 MPa for 6 hours. The reaction solution was subjected to pressure filtration (product name “FUNDABACK FILTER” manufactured by Ishikawajima Harima Heavy Industries, Ltd.) at a pressure of 0.25 MPa using Radiolite #500 as a filtration bed to remove the hydrogenation catalyst, thereby obtaining a colorless transparent solution. Then, 0.5 part of an antioxidant:pentaerythritol tetrakis[3-(3,5-di-t-butyl-4-hydroxyphenyl)propionate] (manufactured by Ciba Specialty Chemicals, product name “Irganox 1010”) per 100 parts of the hydrogenated product was added to the resulting solution and dissolved. Subsequently, the mixture was successively filtered through a zeta plus filter 30 H (manufactured by Cuno Filter Co., Ltd., having a pore diameter of 0.5 to 1 μm) and further filtered through another metal fiber filter (having a pore diameter of 0.4 μm, manufactured by Nichidai Filter Corporation) to remove minute solid matters. In the solution after filtration, the hydrogenation rate of the hydrogenated product of the ring-opening polymer was 99.9%.

From the solution, the solvent or cyclohexane and other volatile components were removed using a cylindrical concentrator dryer (manufactured by Hitachi, Ltd.) at a temperature of 270° C. and a pressure of 1 kPa or less. The residue after removal of volatile components was extruded in a molten state into a strand form from a die directly connected to the concentrator, and cooled, to thereby obtain pellets of a virgin material of the hydrogenated product of the ring-opening polymer. The pellets had a glass transition temperature of 123° C. and a melt flow rate of 15.0.

A T-die type film melt extruder of a hanger manifold type (stationary type, manufactured by GSI Creos) equipped with a screw having a screw diameter of 20 mmφ, a compression ratio of 3.1, and L/D=30 was prepared.

The above-mentioned pellets were heated and melted by using the above-mentioned film melt extruder to be molded in a form of a film, to thereby obtain a cyclic olefin resin film having a thickness of 13 μm.

(1-2. Support-Layered Body Composite)

The resin film obtained in (1-1) was bonded on one surface of a glass plate (thickness: 0.7 mm) as a support using an adhesive. As the adhesive, an acrylic adhesive (trade name “CS9621” manufactured by Nitto Denko Co., Ltd.) was used. This product was a double-sided tackiness sheet having an adhesive layer with a thickness of 25 μm provided between two release sheets, and was used by appropriately peeling off the release sheets and transferring the adhesive layer onto the support. Thus, a support-layered body composite having a layer structure of (resin film layer)/(adhesive layer)/(glass plate) was obtained. Among these layers, the resin film layer corresponds to the resin layer (R), the adhesive layer corresponds to the laser absorption layer, and the resin film layer and the adhesive layer correspond to the layered body. The thickness T_{A} of the adhesive layer was 25 μm, resulting in a thickness ratio T_{A}/T_{R} of 1.9.

(1-3. Cutting Step)

The surface of the support-layered body composite obtained in (1-2) on the resin film side was perpendicularly irradiated with carbon dioxide laser light having a wavelength of 9.4 μm by a laser light irradiation device (DIAMOND E-250i (manufactured by Coherent, Inc.)) to cut the resin layer (R). Thus, an optical film containing the cut resin layer (R) and the adhesive layer was obtained. The power P of laser light was controlled to 100 W. The laser light for irradiation was pulsed laser light which repeats irradiation and cessation with a period of 20 kHz in frequency. The laser light which is parallel rays having a Gaussian distribution emitted from the irradiation device was shaped by a beam shaper including a DOE (diffractive optical element). Accordingly, the energy distribution of a beam of laser light became approximately uniform flat distribution in a plane direction perpendicular to the optical axis. By moving the irradiation position of laser light on the surface of the resin layer (R), scan cutting of the resin layer (R) was performed. The scanning speed V was 500 mm/s, and the number of scans was once.

(1-4. Evaluation)

The state of the cutting by the cutting step was observed for evaluation. As a result, it was observed that the resin layer (R) was completely cut with no scratch on the support.

### Examples 2 to 4 and Comparative Examples 1 to 4

The conditions for melt extrusion molding of the film in (1-1) were changed to thereby change the thickness of the cyclic olefin resin film to the values shown in Tables 1 and 2. In addition, the thickness of the adhesive layer was changed to the values shown in Table 1. The adhesive layer having a thickness of 50 μm was formed by providing two of the same adhesive layers as that used in Example 1 in a overlaying manner. Except for these matters, the cutting step was performed in the same manner as that in Example 1 to thereby obtain an optical film, and the state of the cutting by the cutting step was observed and evaluated.

### Example 5

(5-1. Preparation of Acrylic Resin Solution)

28 Parts of methyl ethyl ketone and 8 parts of toluene were charged in a reaction vessel equipped with a thermometer, a stirrer, a dropping funnel, and a reflux condenser. The mixture was stirred and heated. After reaching 90° C., a mixture obtained by dissolving 0.16 part of azobisisobutyronitrile (AIBN) as a polymerization initiator in 70 parts of benzyl acrylate, 15 parts of 2-hydroxyethyl acrylate and 15 parts of butyl acrylate was added dropwise over 2 hours. While successively adding a polymerization catalyst solution, in which 0.06 part of AIBN was dissolved in 2 parts of ethyl acetate, during polymerization, polymerization was carried out for 7 hours to obtain an acrylic resin solution (solid content concentration: 65.1%, viscosity: 1300 mPa·s (25° C.), weight-average molecular weight 105,000, number-average molecular weight 36,000, dispersion degree 2.92, glass transition temperature −8.3° C.).

(5-2. Preparation of Adhesive)

0.3 Part of a 55% ethyl acetate solution of a tolylene diisocyanate adduct of trimethylolpropane (“Coronate L-55E” manufactured by Nippon Polyurethane Industry Co., Ltd.) was added to 100 parts (corresponding to solid content) of the acrylic resin solution obtained in (5-1), to prepare a tackiness agent composition. This tackiness agent composition was applied onto a polyester-based release sheet so as to have a film thickness after drying of 10 μm and dried at 100° C. for 4 minutes to form an adhesive layer. In this manner, a two-layer multilayer product having a layer structure of (release sheet)/(adhesive layer) was obtained. After that, a polyester-based release sheet was bonded to the surface of this multilayer product on the adhesive layer side to obtain a three-layered multilayer product having a layer structure of (release sheet)/(adhesive layer)/(release sheet). This was aged under condition of 40° C. for 10 days to obtain a double-sided tackiness sheet.

(5-3. Cutting Step)

Except that the product obtained in (5-2) was used as the adhesive, the cutting step was performed in the same manner as that in Example 1 to thereby obtain an optical film, and the state of the cutting by the cutting step was observed for evaluation.

### Example 6

The conditions for melt extrusion molding of the film in (1-1) were changed to thereby change the thickness of the cyclic olefin resin film to the value shown in Table 1. The laser light used in the cutting step was changed to carbon oxide laser light having a wavelength of 10.6 μm. Except for these matters, the cutting step was performed in the same manner as that in Example 1 to thereby obtain an optical film, and the state of the cutting by the cutting step was observed for evaluation.

### Comparative Example 5

The conditions for melt extrusion molding of the film in (1-1) were changed to thereby change the thickness of the cyclic olefin resin film to the values shown in Table 1. Furthermore, the product obtained in (5-2) was used as the adhesive. In addition, the laser light used in the cutting step was changed to carbon oxide laser light having a wavelength of 10.6 μm using the laser irradiation device (DIAMOND E-250 (manufactured by Coherent Inc.)). Except for these matters, the cutting step was performed in the same manner as that in Example 1 to thereby obtain an optical film, and the state of the cutting by the cutting step was observed for evaluation.

The summary and evaluation results of Examples and Comparative Examples are collectively shown in Tables 1 and 2 below.

TABLE 1

| | Ex. 1 | Ex. 2 | Ex. 3 | Ex. 4 | Ex. 5 | Ex. 6 |
|---|---|---|---|---|---|---|
| Resin layer | 13 | 23 | 47 | 55 | 13 | 23 |
| (R) | | | | | | |
| thickness | | | | | | |
| (μm) | | | | | | |
| Resin layer | 0.04 | 0.04 | 0.05 | 0.05 | 0.04 | 0.04 |
| (R) average | | | | | | |
| absorbance | | | | | | |
| A_{R} | | | | | | |
| Laser | 25 | 25 | 50 | 50 | 10 | 25 |
| absorption | | | | | | |
| layer | | | | | | |
| thickness | | | | | | |
| (μm) | | | | | | |
| T_{A}/T_{R} | 1.9 | 1.1 | 1.1 | 0.9 | 0.8 | 1.1 |
| Laser | 9.4 μm | 9.4 μm | 9.4 μm | 9.4 μm | 9.4 μm | 10.6 μm |
| wavelength | | | | | | |
| Cutting | Good | Good | Good | Good | Good | Good |
| state | | | | | | |
| evaluation¹⁾ | | | | | | |

TABLE 2

| | Comp. | Comp. | Comp. | Comp. | Comp. |
|---|---|---|---|---|---|
| | Ex. 1 | Ex. 2 | Ex. 3 | Ex. 4 | Ex. 5 |
| Resin layer | 25 | 47 | 23 | 60 | 23 |
| (R) | | | | | |
| thickness | | | | | |
| (μm) | | | | | |
| Resin layer | 0.04 | 0.05 | 0.04 | 0.05 | 0.04 |
| (R) average | | | | | |
| absorbance | | | | | |
| A_{R} | | | | | |
| Laser | 5 | 25 | 10 | 25 | 10 |
| absorption | | | | | |
| layer | | | | | |
| thickness | | | | | |
| (μm) | | | | | |
| T_{A}/T_{R} | 0.2 | 0.5 | 0.4 | 0.4 | 0.4 |
| Laser | 9.4 μm | 9.4 μm | 9.4 μm | 9.4 μm | 10.6 μm |
| wavelength | | | | | |
| Cutting | Failure | Failure | Failure | Failure | Failure |
| state | | | | | |
| evaluation¹⁾ | | | | | |

1) Good: It was observed that the resin layer (R) was completely cut with no scratch on the support.

Failure: An uncut portion remained in the resin layer (R).

As understood from the aforementioned result, smooth cutting of the resin layer (R) was successfully achieved by the production method according to Examples in which conditions such as the ratio T_{A}/T_{R} satisfy the requirements of the present invention, compared to that according to Comparative Examples in which the ratio T_{A}/T_{R} does not fall within the range of the requirements of the present invention.

### REFERENCE SIGN LIST

100: support-layered body composite
110: layered body
111: resin layer (R)
112: laser absorption layer
120: support
200: laser light irradiation device

1. A method for producing an optical film, comprising a cutting step of irradiating a layered body with laser light to cut the resin layer, the layered body including a resin layer and a laser absorption layer disposed on one surface of the resin layer, wherein
an average absorbance A_{A} of light in a wavelength range of 9 μm or more and 11 μm or less by the laser absorption layer is larger than an average absorbance A_{R} of light in the wavelength range of 9 μm or more and 11 μm or less by the resin layer, and
a ratio T_{A}/T_{R} of a thickness T_{A} of the laser absorption layer relative to a thickness T_{R} of the resin layer is 0.8 or more.

2. The method for producing an optical film according to claim 1, wherein the average absorbance A_{A} by the laser absorption layer is 0.07 or more.

3. The method for producing an optical film according to claim 1, wherein the irradiation with the laser light is performed so that an energy distribution of a beam of the laser light is a flat-shape energy distribution.

4. The method for producing an optical film according to claim 1, wherein the resin layer is a layer of a thermoplastic resin containing a cyclic olefin polymer.

5. The method for producing an optical film according to claim 1, wherein the laser absorption layer is a layer of a resin containing an ester compound.

6. The method for producing an optical film according to claim 5, wherein the resin containing the ester compound is an acrylic adhesive.

7. The method for producing an optical film according to claim 1, wherein the laser light has a wavelength falling within a range of 9 μm or more and 11 μm or less.

8. The method for producing an optical film according to claim 1, wherein
the cutting step includes forming a support-layered body composite including a support, the laser absorption layer, and the resin layer in this order, and
the irradiation with the laser light includes irradiating the support-layered body composite with the laser light onto a side of the resin layer.
